(19) United States
(12) Patent Application Publication
(10) Pub. No.: US 2021/0357363 A1
(43) Pub. Date: Nov. 18, 2021

(54) FILE COMPARISON METHOD

(71) Applicant: 1E Ltd, London (GB)

(72) Inventor: Andrew MAYO, Maidenhead (GB)

(21) Appl. No.: 17/316,064

(22) Filed: May 10, 2021

(30) Foreign Application Priority Data
May 13, 2020 (GB) 2007055.3

(51) Int. Cl. G06F 16/14; G06F 16/13; G06F 16/182; G06F 16/903

(52) U.S. Cl. CPC G06F 16/152; G06F 16/137; G06F 16/90344; G06F 16/182; G06F 16/144

(57) ABSTRACT

A method of comparing a candidate file with an exemplar file, includes: receiving a candidate file comprising candidate file data; processing the candidate file data to generate a candidate file fingerprint representing the candidate file, the candidate file fingerprint comprising a plurality of fingerprint strings each representing a portion of the candidate file data; and comparing the candidate file fingerprint with an exemplar file fingerprint representing the exemplar file, the exemplar file comprising exemplar file data and the exemplar file fingerprint comprising a plurality of fingerprint strings each representing a portion of the exemplar file data. A candidate file fingerprint is generated by applying a rolling hash function to the candidate file data to generate a sequence of strings, and adding to the candidate file fingerprint a fingerprint string comprising a substring from the sequence of strings when a predetermined string pattern appears in the sequence of strings.

### CROSS-REFERENCE TO RELATED APPLICATIONS

This application claims priority to UK Application No. GB 2007055.3, filed May 13, 2020, under 35 U.S.C. § 119(a). The above-referenced patent application is incorporated by reference in its entirety.

### BACKGROUND OF THE INVENTION

### Technical Field

The present disclosure relates to the field of software fingerprinting. It finds application in the software field in general. More particularly it relates to generating a fingerprint of a software file in order to identify the software file and thereby compare it with another software file. It may for example be used to fingerprint and thereby compare program files, which are also known as executables.

### Description of the Related Technology

Software files, for example program files or executables (e.g. *.exe, *.dll), are conventionally identified as pertaining to a particular program, and more specifically to a version thereof.

Historically, it was feasible to identify executables or program files on a computer by reference to file metadata or to other attributes that are stored with the file. These techniques can be used even if the file names or even file contents are slightly different, e.g. due to being different versions of the same program. For example, the metadata may identify the originator: “Adobe®”, the program: “Acrobat®”, and its version: “11.0”. It would then be easy to identify another program with metadata “Adobe®”: “Acrobat®”: “11.1” as being a later version of the same program, even though the file contents would tend to differ, without recourse to any other kind of analysis.

Having this knowledge conveniently enables computer system managers to manage installed software across large estates of computers. For example, the knowledge can be used to audit and track installed software or cleanse computer systems, for instance by removing old versions of software. In other instances, checks can be made to ensure that all installed software is correctly licensed, by comparing license information (e.g. we have a license for v11.0 of some software) with the software that is installed on a computer (e.g. anyone found to be running v11.1 is not licensed to do so).

However there remains room for improvements in identifying and comparing software files. Program files relating to Open Source software may lack file metadata or other attributes, making it difficult to use such known techniques to identify and compare programs. The ability to reliably identify or compare files may also be useful in cases where it is possible to fake the file metadata or other attributes so that a program with a virus appears to be legitimate. These problems are particularly acute for organisations wishing to manage and optimise large estates of computers.

Thus, a need exists for improved techniques for identifying and comparing software files.

### SUMMARY

According to a first aspect of the present disclosure a method of comparing a candidate file with an exemplar file is provided. The method includes:
receiving a candidate file comprising candidate file data;
processing the candidate file data to generate a candidate file fingerprint representing the candidate file, the candidate file fingerprint comprising a plurality of fingerprint strings each representing a portion of the candidate file data; and
comparing the candidate file fingerprint with an exemplar file fingerprint representing the exemplar file, the exemplar file comprising exemplar file data and the exemplar file fingerprint comprising a plurality of fingerprint strings each representing a portion of the exemplar file data;
wherein, processing the candidate file data to generate a candidate file fingerprint representing the candidate file, comprises: applying a rolling hash function to the candidate file data to generate a sequence of strings, and adding to the candidate file fingerprint a fingerprint string comprising a substring from the sequence of strings when a predetermined string pattern appears in the sequence of strings.

According to a second aspect of the present disclosure a method of generating a candidate file fingerprint representing a candidate file is provided. This method includes:
receiving a candidate file comprising candidate file data; and
processing the candidate file data to generate a candidate file fingerprint representing the candidate file, the candidate file fingerprint comprising a plurality of fingerprint strings each representing a portion of the candidate file data;
wherein, processing the candidate file data to generate a candidate file fingerprint representing the candidate file, comprises: applying a rolling hash function to the candidate file data to generate a sequence of strings, and adding to the candidate file fingerprint a fingerprint string comprising a substring from the sequence of strings when a predetermined string pattern appears in the sequence of strings.

A similar method may be used to generate the exemplar file fingerprint of the exemplar file.

In accordance with the nomenclature used herein the term “exemplar” file refers to a reference, or authentic version of a file, and against which a sample file, i.e. the “candidate” file is compared. The terms “candidate” and “exemplar” are therefore purely labels used to distinguish between these files.

In some examples of the present disclosure the candidate file and the exemplar file are described as being a program file; a program file being defined herein as a file comprising software code used to run a program. The software code may be un-compiled, or it may have been compiled. In other words it may be source code or machine code. A program file is also commonly referred to as an executable file. Executable files are ubiquitous in the Microsoft® Windows® operating system and typically have the file extension “*.exe”. However, the present disclosure also finds application with other types of program files such as, and without limitation, Dynamic Link Library (*.DLL) files that are used in conjunction with such executable files. It is therefore to be appreciated that the candidate file and the exemplar file may in general be any software file. The present disclosure may therefore be used with files having different file extensions to *.exe, and *.DLL, for example with data files or document files, as well as with files that have no file extension at all. It is also noted that the present disclosure finds application with different operating systems to Microsoft® Windows®. Non-limiting examples of alternative operating systems in which the present disclosure also finds application include: Linux®, macOS (formerly OS X), iOS and Android.

As described in more detail below, the methods described herein may be implemented by a computer. The methods may therefore be carried out by a combination of software and hardware. Such a combination may for instance include one or more processors and one or more memories that store instructions corresponding to the method, and which instructions when carried out on the processor cause the processor to carry out the described instructions.

Further features and advantages of the present disclosure will become apparent from the following description, which is made with reference to the accompanying drawings.

### BRIEF DESCRIPTION OF THE DRAWINGS

FIG. 1 is a flow diagram that illustrates a method of generating a candidate file fingerprint CFF representing a candidate file CF in accordance with some aspects of the present disclosure.

FIG. 2 is a schematic diagram that illustrates the generation of a candidate file fingerprint CFF from candidate file data CFD by applying a rolling hash function RHF to the candidate file data CFD to generate a sequence of strings SOS.

FIG. 3 is a schematic diagram that illustrates the application of a submask SM to the sequence of strings SOS wherein values in the submask SM and values in the sequence of strings SOS are compared at corresponding positions P_{1 . . . n}.

FIG. 4 is a schematic diagram that illustrates the simultaneous generation of a second candidate file fingerprint SCFF and a candidate file fingerprint CFF from candidate file data CFD.

FIG. 5 is a flow diagram that illustrates a method of comparing a candidate file CF with an exemplar file EF using their respective file fingerprints CFF, EFF.

### DETAILED DESCRIPTION OF CERTAIN INVENTIVE EMBODIMENTS

Some examples described herein provide a method of generating a candidate file fingerprint representing a candidate file. Other examples described herein relate to a method of comparing a candidate file with an exemplar file using the candidate file fingerprint. One example relates to a computer program product. It is to be appreciated that features described in relation to one example may equally be used in another example and that all features are not necessarily duplicated in each example for the sake of brevity.

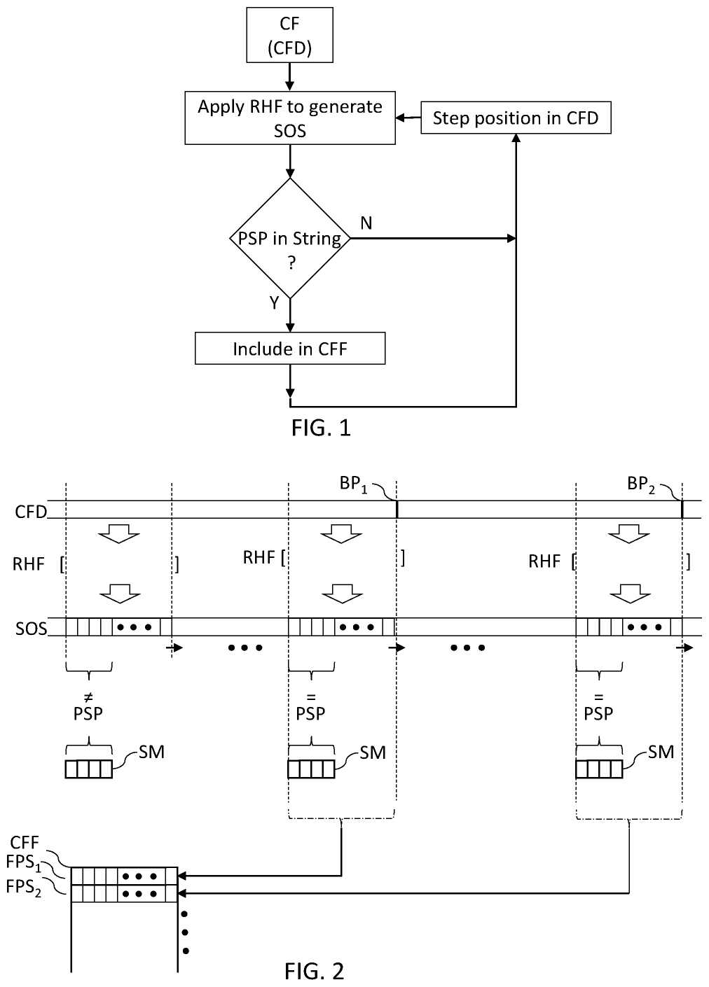

FIG. 1 is a flow diagram that illustrates a method of generating a candidate file fingerprint CFF representing a candidate file CF in accordance with some aspects of the present disclosure. With reference to FIG. 1, the method includes:
receiving a candidate file CF comprising candidate file data CFD; and
processing the candidate file data CFD to generate a candidate file fingerprint CFF representing the candidate file CF, the candidate file fingerprint CFF comprising a plurality of fingerprint strings FPS_{1 . . . m} each representing a portion of the candidate file data CFD;
wherein, processing the candidate file data CFD to generate a candidate file fingerprint CFF representing the candidate file CF, comprises: applying a rolling hash function RHF to the candidate file data CFD to generate a sequence of strings SOS, and adding to the candidate file fingerprint CFF a fingerprint string FPS_{1 . . . m} comprising a substring from the sequence of strings SOS when a predetermined string pattern PSP appears in the sequence of strings SOS.

The above method is illustrated in more detail in FIG. 2, which is a schematic diagram that illustrates the generation of a candidate file fingerprint CFF from candidate file data CFD by applying a rolling hash function RHF to the candidate file data CFD to generate a sequence of strings SOS.

With reference to FIG. 1 and FIG. 2, the input to the method is a candidate file CF that includes candidate file data CFD. Candidate file CF, and thus candidate file data CFD, may be received, i.e. read, from a memory. The memory may be any computer readable storage medium such as a semiconductor or solid state memory, a magnetic tape, a removable computer disk, a random access memory “RAM”, a read only memory “ROM”, a flash memory, a rigid magnetic disk, a Redundant Array of Independent Disks “RAID”, and an optical disk and so forth. Moreover the candidate file CF may be received from a memory that is local to where the candidate file is processed in the method, or received from a remote location, for example via the Internet, from the “Cloud”, or via another communication network. By way of one non-limiting example, candidate file data CFD may include compiled source code of Adobe® Acrobat® Version 11.1.

After receiving the candidate file CF, the candidate file data CFD is processed to generate a candidate file fingerprint CFF representing the candidate file CF. The candidate file fingerprint CFF includes a plurality of fingerprint strings FPS_{1 . . . m}, each representing a portion of the candidate file data CFD. The processing involves applying a rolling hash function RHF to the candidate file data CFD in order to generate a sequence of strings SOS.

Broadly speaking, a hash function maps a string of input data elements to a string of output data elements. A string of data elements is a sequence of characters of an alphabet, such as 1's and 0's, or other characters. The string of output data elements generated by the hash function is sometimes termed a “hash string” or simply a “hash”. Hash functions are typically chosen on the basis that the chance of “collisions”, i.e. the mapping of different strings of input data elements to the same string of output data elements, is negligible. In so doing, the hash can be thought of as providing a near unique identifier of the string of input data elements.

In the method of the present disclosure, a rolling hash function RHF is applied to portions of the candidate file data CFD, i.e. to strings of input data elements, in order to generate the sequence of strings SOS, i.e. strings of output data elements. A rolling hash function is used in particular because rolling hash functions can generate hash strings that are characteristic of the strings of input data elements in a computationally-efficient manner. This is now described with reference to FIG. 2.

In the upper part of FIG. 2, rolling hash function RHF is applied to a windowed portion of the candidate file data CFD in order to generate a string of output data elements. The window is indicated by the dashed vertical lines in FIG. 2. As indicated by the horizontal, right-pointing arrows in FIG. 2, the position of the window is then stepped through the candidate file data CFD, typically by one or more input data elements and a string of output data elements is generated at the new window position. The strings of output data elements that are generated by stepping the window of the rolling hash function RHF through the candidate file data CFD in this manner form a sequence of strings SOS. The use of a rolling hash function is computationally efficient at generating these strings, or hashes, because a rolling hash function computes the hash at a current window position using the hash at a previous window position. For example, if we assume the window moves, by a step of one input data element, from a previous window position containing a certain number of input data elements to a current window position containing the same number of input data elements, that means that one input data element enters at the front of the window and one input data element leaves from the back of the window. The rolling hash function does not need to re-compute the hash value for all input data elements in the current window position. Rather, the hash at the current window position may be computed using the hash at the previous window position, by subtracting the computed contribution due to the leaving input data element and adding the computed contribution from the new, entering input data element. Thus, using a rolling hash function obviates the need to re-compute the contribution to the hash from every input data element within the current window position each time the window position is stepped.

Various rolling hash functions are suitable for generating each string of output data elements in the sequence of strings SOS. One example is the polynomial rolling hash, H:

H=c₁a^{m-1}+c₂a^{m-2}+c₃a^{m-3}+ . . . +cₘa⁰ Equation 1

Here, a is a constant and c_{1 . . . m} are the input data elements. The result of H may be computed as modulo p, wherein p may be a prime number. In order to reduce the chance of collisions, p may be a large prime number and/or a may be larger than the alphabet of possible input data elements.

Other types of rolling hash may alternatively be used, including the Rabin fingerprint, and the Cyclic polynomial. In one implementation, the Rabin-Karp Rolling Hash algorithm is used. This is described in document: “Efficient randomized pattern-matching algorithms”; IBM Journal of Research and Development, Volume: 31, Issue: 2, March 1987.

Returning to the above method, as indicated in FIG. 1 and FIG. 2, the sequence of strings SOS generated by the rolling hash function RHF is then used to provide a candidate file fingerprint CFF.

With reference to the decision box in FIG. 1; at each of the aforementioned window positions it is determined whether a predetermined string pattern PSP appears in the string of output data elements that is generated by the rolling hash function RHF. In other words, it is determined whether a predetermined string pattern PSP appears in the sequence of strings SOS. If the predetermined string pattern PSP does appear in the sequence of strings SOS, a fingerprint string FPS_{1 . . . m}, which includes a substring from the sequence of strings SOS, is added to, i.e. included in, the candidate file fingerprint CFF. The substring may be a portion of the string of output data elements that is generated by the rolling hash function RHF, or alternatively the entire string of output data elements that is generated by the rolling hash function RHF; at the relevant window position. The position in the candidate file data CFD at which this occurs may be termed a boundary position BP_{1 . . . k} as exemplified by boundary position BP₁ in FIG. 2. The window position is then stepped, typically by one input data element, in the candidate file data CFD. A string of output data elements is then calculated using the rolling hash function RHF at the new window position, and the same determination is made with respect to the predetermined string pattern PSP. In the alternative, i.e. if the predetermined string pattern PSP does not appear in the string of output data elements, the window position is stepped without including any portion of the string of output data elements in the candidate file fingerprint CFF, and the same determination is made with respect to the predetermined string pattern PSP in the new window position. This procedure is repeated for the remainder of the candidate file data CFD. In so doing, the candidate file fingerprint CFF is built-up from the fingerprint strings FPS_{1 . . . m}; i.e. by adding a fingerprint string FPS_{1 . . . m} to the candidate file fingerprint CFF each time a boundary position BP_{1 . . . k} is identified.

In some implementations, the substring from the sequence of strings SOS that is added to the candidate file fingerprint CFF in the above method is the entire string of output data elements that is generated by the rolling hash function RHF at the window position at which the determination is made. However, a reduction in the size of the candidate file fingerprint CFF may be achieved by including in the candidate file fingerprint CFF only a portion, i.e. not the whole, of the string of output data elements that is generated by the rolling hash function RHF at the window position at which the determination is made. In particular, it is noted that the predetermined string pattern PSP within each string of output data elements generated by the rolling hash function RHF that triggers the inclusion of a substring in the candidate file fingerprint CFF, “triggering string”, is the same for each triggering string. The predetermined string pattern PSP part of each triggering string therefore has only a minor contribution to the distinctiveness of each fingerprint. In order to reduce the size of a fingerprint, the predetermined string pattern PSP part, or another selection of data in the triggering string, may therefore be omitted from each fingerprint string FPS_{1 . . . m}.

The predetermined string pattern PSP that is used in the above-described determination corresponds to a selection of one or more characters of each string of output data elements generated by the rolling hash function RHF. By way of an example implementation, a string of output data elements generated by the rolling hash function RHF may for instance have 64-bits and the predetermined string pattern PSP may correspond to the lowest 10-bits of the string having a zero, “0” value. With this implementation, a portion or all of a string of output data elements generated by the rolling hash function RHF would be included in the candidate file fingerprint CFF each time the lowest 10-bits of the string are all 0's. Different predetermined string patterns, for example patterns that make different selections of the characters in each string of output data elements generated by the rolling hash function RHF, or patterns having different values to the example 0 values above, may alternatively be used to trigger the inclusion of a fingerprint string FPS_{1 . . . m} in the candidate file fingerprint CFF in a similar manner.

In some implementations, rather than including in the candidate file fingerprint CFF a substring from the string of output data elements generated by the rolling hash function RHF at the window position in which the predetermined string pattern PSP appears, it may alternatively be a substring from another string of output data elements generated by the rolling hash function RHF that is included in the candidate file fingerprint CFF when the predetermined string pattern PSP appears in the sequence of strings SOS. It may for instance be a substring from a string of output data elements generated by the rolling hash function RHF that is near to, i.e. within approximately ±1-10 window positions of, the string of output data elements generated by the rolling hash function RHF in which the predetermined string pattern PSP appears, that is included in the candidate file fingerprint CFF.

Summarising the above, a fingerprint string FPS_{1 . . . m} comprising a substring from the sequence of strings SOS is added to the candidate file fingerprint CFF when a predetermined string pattern PSP appears in the sequence of strings SOS.

As mentioned above, the use of a rolling hash function RHF in the above-described method is computationally efficient at generating hashes. The use of a rolling hash function is also computationally efficient in generating the candidate file fingerprint CFF because it provides a mechanism for quickly determining at each window position whether or not to include a substring from the sequence of strings SOS in the candidate file fingerprint CFF.

After the candidate file fingerprint CFF has been generated, it may be stored in a memory or database, for example as an array, and/or linked to the candidate file CF. For example, the candidate file fingerprint CFF may be linked to the candidate file CF by providing the file fingerprint CFF with a pointer that points to the candidate file CF. The candidate file fingerprint CFF may alternatively or additionally be reported in combination with the name of the candidate file CF.

Candidate file fingerprints generated using the above method have advantageously been found to require only modest data storage requirements. Candidate file fingerprints CFF generated in accordance with some examples of the present disclosure have been generated that are in the order of 0.25% of the size of the candidate file CF. This value may be increased or decreased by varying the length of the predetermined string pattern PSP. The modest data storage requirements arise from only including fingerprint strings FPS_{1 . . . m} in the candidate file fingerprint CFF when a predetermined string pattern PSP appears in the sequence of strings SOS. More particularly, it is because each substring that is included in the candidate file fingerprint is (a portion of) a string of output data elements that are generated by the rolling hash function RHF. Thus, the method of the present disclosure contrasts with other methods in which hashes of all the data in a file are included in a file fingerprint. Candidate file fingerprints generated in accordance with examples of the present disclosure have also been found to require only modest processing time. In some tests, around 4000 fingerprints per minute were generated. This makes the present disclosure particularly suitable for implementation across large estates of computers. In some examples, fingerprints may be generated on a single core of a processor, thereby avoiding interruptions to a user, or to other processor processes.

A further advantage offered by examples of the method of the present disclosure, specifically relating to the use of strings of output data elements generated by a rolling hash function RHF to trigger the inclusion of a substring in the candidate file fingerprint CFF, is that it provides fingerprints that are relatively robust to trivial data insertions or deletions to candidate file data CFD. Such changes tend to have a minor impact on the candidate file fingerprint CFF because they typically only affect fingerprint strings FPS_{1 . . . m} that are local to the change. Specifically, a fingerprint string FPS_{1 . . . m} is typically only altered, or removed, if a change occurs at a position at which a boundary positions BP_{1 . . . k} would have been generated in the candidate file data CFD, or if the change generates a new boundary position BP_{1 . . . k} in the candidate file data CFD.

Referring again to FIG. 2, in order to determine when a predetermined string pattern PSP appears in the sequence of strings SOS, a submask SM may be applied to the sequence of strings SOS. Applying a submask SM to the sequence of strings SOS comprises:

for each of n positions P_{1 . . . n} in the submask SM, comparing a value in the submask SM with a corresponding value in each string in the sequence of strings SOS, and adding to the candidate file fingerprint CFF a fingerprint string FPS_{1 . . . m} comprising a substring from the sequence of strings SOS if every value in the submask SM is identical to its corresponding value in the string in the sequence of strings SOS.

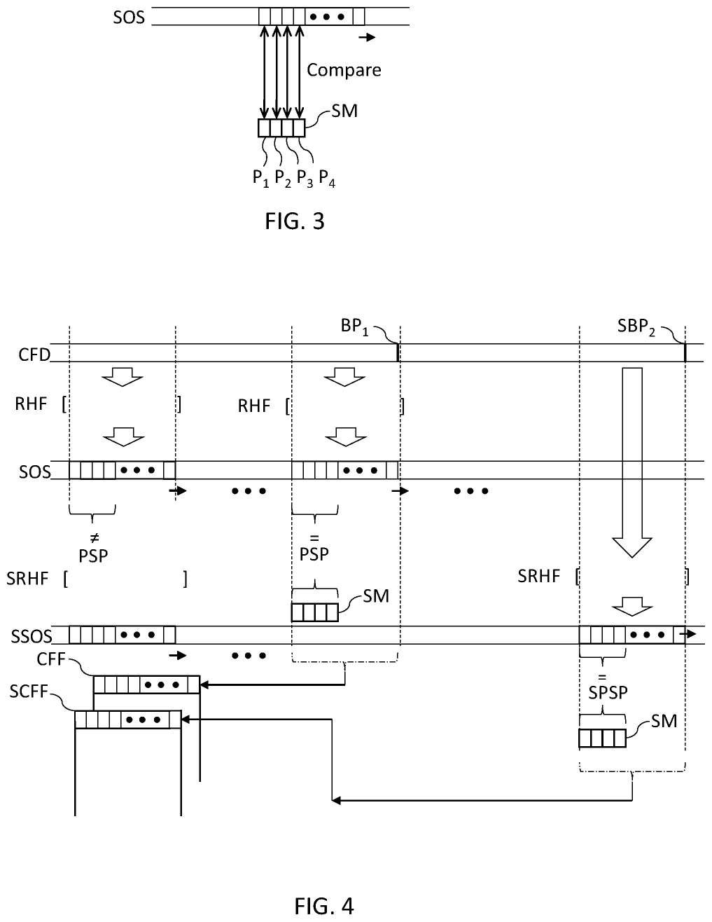

This is illustrated in more detail in FIG. 3, which is a schematic diagram that illustrates the application of a submask SM to the sequence of strings SOS wherein values in the submask SM and values in the sequence of strings SOS are compared at corresponding positions P_{1 . . . n}. Submask SM is thus applied to each string of output data elements generated by the rolling hash function RHF.

In general, the likelihood of the predetermined string pattern PSP appearing in the sequence of strings SOS decreases as the length of the predetermined string pattern PSP increases. Increasing the length of the predetermined string pattern PSP therefore reduces the number of fingerprint strings FPS_{1 . . . m} that are added to the candidate file fingerprint CFF. In some examples, distinctive file fingerprints may be generated with between 100 and 200 fingerprint strings. A tradeoff may therefore be made between the number of fingerprint strings in a candidate file fingerprint, the length of the predetermined string pattern PSP, and the distinctiveness of the fingerprint.

In some candidate files there can be large amounts of similar data. This may be due to the presence of long strings of identical characters or due to large gaps between different sections of a file. When a rolling hash function is applied to such data it will tend to also produce identical strings, particularly when the width of the strings of identical data exceeds the width of the window applied to the input data. Including identical strings in the candidate file fingerprint CFF adds to its size but contributes little to its distinctiveness. In order to reduce the size of the candidate file fingerprint CFF, it may therefore be beneficial to only include distinct strings in the candidate file fingerprint CFF. In order to do this, in some implementations, only distinct fingerprint strings are added to the candidate file fingerprint. In other words; adding to the candidate file fingerprint CFF a fingerprint string FPS_{1 . . . m} comprising a substring from the sequence of strings SOS when a predetermined string pattern PSP appears in the sequence of strings SOS, may comprise:

only adding to the candidate file fingerprint CFF a fingerprint string FPS_{1 . . . m} comprising a substring from the sequence of strings SOS if said fingerprint string is distinct from every other fingerprint string already included in the candidate file fingerprint CFF.

Using the above-described method, one or more additional candidate file fingerprints may also be generated from the same candidate file in a similar manner, each using a different rolling hash function. Advantageously the file fingerprints may be generated simultaneously in order to save time. This is illustrated in FIG. 4, which is a schematic diagram that illustrates the simultaneous generation of a second candidate file fingerprint SCFF and a candidate file fingerprint CFF from candidate file data CFD.

In order to generate such a second fingerprint, the above-described method of generating a candidate file fingerprint can further include:

processing the candidate file data CFD to generate a second candidate file fingerprint SCFF representing the candidate file CF, the second candidate file fingerprint SCFF comprising a plurality of fingerprint strings each representing a portion of the candidate file data CFD;

wherein, processing the candidate file data CFD to generate a second candidate file fingerprint SCFF representing the candidate file CF, comprises: applying a second rolling hash function SRHF to the candidate file data CFD to generate a second sequence of strings SSOS, and adding to the second candidate file fingerprint SCFF a fingerprint string comprising a substring from the second sequence of strings SSOS when a second predetermined string pattern SPSP appears in the second sequence of strings SSOS; and

wherein the second candidate file fingerprint SCFF is generated simultaneously with the candidate file fingerprint CFF.

The second rolling hash function SRHF is different to the rolling hash function RHF. As with the rolling hash function RHF described above, various rolling hash functions may be used for the second rolling hash function SRHF. With reference to Equation 1, the second rolling hash function SRHF may for instance use a different value for constant a to rolling hash function RHF. In one implementation the Rabin-Karp Rolling Hash algorithm is used.

The above-described candidate file fingerprint CFF finds particular application in comparing the candidate file CF with an exemplar file EF. The method may for instance be used to determine how closely the two files match. The exemplar file EF may for example be an authentic version of a program file such as Adobe Acrobat version 11.1 and the method may be used to determine whether the candidate file CF is indeed the same version as the exemplar file EF based on the closeness of the match.

Thereto, a method of comparing a candidate file CF with an exemplar file EF includes:
receiving a candidate file CF comprising candidate file data CFD;
processing the candidate file data CFD to generate a candidate file fingerprint CFF representing the candidate file CF, the candidate file fingerprint CFF comprising a plurality of fingerprint strings FPS_{1 . . . m} each representing a portion of the candidate file data CFD; and
comparing the candidate file fingerprint CFF with an exemplar file fingerprint EFF representing the exemplar file EF, the exemplar file comprising exemplar file data and the exemplar file fingerprint EFF comprising a plurality of fingerprint strings each representing a portion of the exemplar file data;
wherein, processing the candidate file data CFD to generate a candidate file fingerprint CFF representing the candidate file CF, comprises: applying a rolling hash function RHF to the candidate file data CFD to generate a sequence of strings SOS, and adding to the candidate file fingerprint CFF a fingerprint string FPS_{1 . . . m} comprising a substring from the sequence of strings SOS when a predetermined string pattern PSP appears in the sequence of strings SOS.

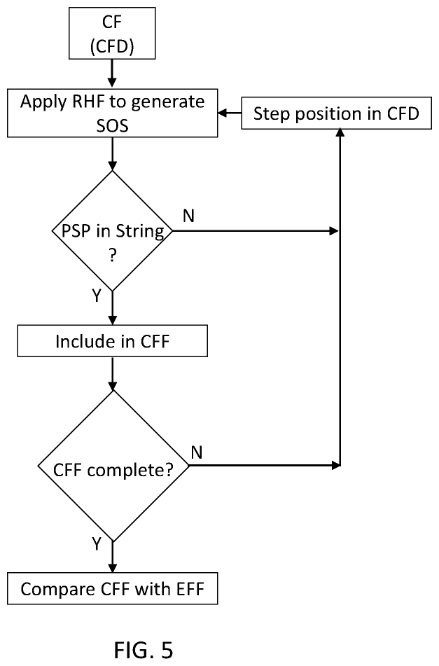

This method is illustrated with reference to FIG. 5, which is a flow diagram that illustrates a method of comparing a candidate file CF with an exemplar file EF using their respective file fingerprints CFF, EFF. The method follows the same procedure for generating a candidate file fingerprint CFF that was described above with reference to FIG. 1 for the exemplar file fingerprint EFF. After generating the candidate file fingerprint CFF it is compared with an exemplar file fingerprint EFF.

A value indicative of the similarity of the comparison may also be computed. This may subsequently be stored, or reported to a user.

The exemplar file fingerprint EFF representing the exemplar file EF is generated in a similar manner as the aforementioned candidate file fingerprint CFF; specifically by:
receiving an exemplar file EF comprising exemplar file data EFD; and
processing the exemplar file data EFD to generate an exemplar file fingerprint EFF representing the exemplar file EF, the exemplar file fingerprint EFF comprising a plurality of fingerprint strings each representing a portion of the exemplar file data EFD;
wherein, processing the exemplar file data EFD to generate an exemplar file fingerprint EFF, comprises: applying the rolling hash function RHF to the exemplar file data EFD to generate a sequence of strings, and adding to the exemplar file fingerprint EFF a fingerprint string comprising a substring from the sequence of strings when the predetermined string pattern PSP appears in the sequence of strings SOS.

In the method of comparing a candidate file CF with an exemplar file EF, the comparison between the candidate file fingerprint CFF and the exemplar file fingerprint EFF may for instance be determined based on the proportion of fingerprint strings FPS_{1 . . . m} in the candidate file fingerprint CFF that correspond to fingerprint strings in the exemplar file fingerprint EFF. In one implementation, comparing the candidate file fingerprint CFF with an exemplar file fingerprint EFF representing the exemplar file EF, comprises:

calculating a Jaccard similarity index across the fingerprint strings of the candidate file fingerprint CFF and the exemplar file fingerprint EFF.

The Jaccard similarity index J(X, Y) may be computed from the fingerprint strings X in the candidate file fingerprint CFF and the fingerprint strings Y in the exemplar file fingerprint EFF using Equation 2:

J(X,Y)=|X∩Y|/|X∪Y| Equation 2

It may also be useful to indicate whether a match between the candidate file CF and the exemplar file EF has been obtained. Comparing the candidate file fingerprint CFF with an exemplar file fingerprint EFF representing the exemplar file EF, may therefore comprise:
computing a value indicative of the similarity of the comparison, and
indicating, based on a predetermined threshold of the value, that the candidate file CF matches the exemplar file EF.

An exact match may for instance be represented by 1.0 and the predetermined threshold may for instance be 0.85 such that if the value indicative of the similarity of the comparison is greater than or equal to 0.85 the candidate file CF matches the exemplar file EF.

It may also be useful to determine whether a match exists between multiple candidate files and the exemplar file EF. In this case the method of comparing the candidate file CF with the exemplar file EF may include:
receiving at least a second candidate file comprising second candidate file data; and
processing the at least a second candidate file data to generate at least a second candidate file fingerprint representing the at least a second candidate file, the at least a second candidate file fingerprint comprising a plurality of fingerprint strings each representing a portion of the at least a second candidate file data; and
wherein, processing the at least a second candidate file data to generate at least a second candidate file fingerprint representing the at least a second candidate file, comprises: applying the rolling hash function RHF to the at least a second candidate file data to generate a sequence of strings, and adding to the candidate file fingerprint a fingerprint string comprising a substring from the sequence of strings when the predetermined string pattern PSP appears in the sequence of strings SOS; and
wherein the candidate file CF and the at least a second candidate file are disposed in a common directory, or on a common disk, or distributed across an estate of computers and/or associated storage systems.

The comparison between the candidate file CF and the exemplar file EF as described in accordance with examples of the present disclosure has been found to be reliable because the fingerprints used in the comparison are determined by analysing data throughout the candidate file CF and the exemplar file EF. By contrast, techniques used to compare files based purely on file header information or a name of a file extension may be subject to malicious attempts to mask their appearance. Moreover, the file fingerprints generated in accordance with examples of the present disclosure and which are used in the comparison can be generated quickly and have a small size. This simplifies the processing and memory requirements of systems that are used to compare candidate files with exemplar files. Thus, the methods described herein enable systems managers to reliably manage installed software across large estates of computers. For example, the knowledge can be used to audit and track installed software or cleanse computer systems, for instance by removing old versions of software. In other instances, checks can be made to ensure that all installed software is correctly licensed, by comparing licence information (e.g. we have a licence for v11.0 of some software) with the software that is installed on a computer (e.g. anyone found to be running v11.1 is not licensed to do so).

Examples of the methods described herein may be provided in the form of a non-transitory computer-readable storage medium comprising a set of computer-readable instructions stored thereon which, when executed by at least one processor, cause the at least one processor to perform the method.

Examples of the present disclosure may also be provided in the form of a computer program product. The computer program product can be provided by dedicated hardware or hardware capable of running the software in association with appropriate software. When provided by a processor, these functions can be provided by a single dedicated processor, a single shared processor, or multiple individual processors that some of the processors can share. Moreover, the explicit use of the terms “processor” or “controller” should not be interpreted as exclusively referring to hardware capable of running software, and can implicitly include, but is not limited to, digital signal processor “DSP” hardware, read only memory “ROM” for storing software, random access memory “RAM”, flash memory, a nonvolatile storage device, and the like.

Furthermore, examples of the present disclosure can take the form of a computer program product accessible from a computer usable storage medium or a computer readable storage medium, the computer program product providing program code for use by or in connection with a computer or any instruction execution system. For the purposes of this description, a computer-usable storage medium or computer-readable storage medium can be any apparatus that can comprise, store, communicate, propagate, or transport a program for use by or in connection with an instruction execution system, apparatus, or device. The medium can be an electronic, magnetic, optical, electromagnetic, infrared, or semiconductor system or device or propagation medium. Examples of computer readable media include semiconductor or solid state memories, magnetic tape, removable computer disks, random access memory “RAM”, read only memory “ROM”, rigid magnetic disks, a Redundant Array of Independent Disks “RAID”, and optical disks. Current examples of optical disks include compact disk-read only memory “CD-ROM”, optical disk-read/write “CD-R/W”, Blu-Ray™, and DVD.

The above implementations and examples are to be understood as illustrative examples of the disclosure. Further implementations and examples of the disclosure are also envisaged. It is to be understood that any feature described in relation to any one implementation may be used alone, or in combination with other features described, and may also be used in combination with one or more features of any other implementation, or any combination of the implementations. Any reference signs in the claims should not be construed as limiting the scope. Furthermore, equivalents and modifications not described above may also be employed without departing from the scope of the disclosure, which is defined in the accompanying claims.

What is claimed is:

1. A method of comparing a candidate file with an exemplar file, comprising:
receiving the candidate file comprising candidate file data;
processing the candidate file data to generate a candidate file fingerprint representing the candidate file, the candidate file fingerprint comprising a plurality of fingerprint strings each representing a portion of the candidate file data; and
comparing the candidate file fingerprint with an exemplar file fingerprint representing the exemplar file, the exemplar file comprising exemplar file data and the exemplar file fingerprint comprising a plurality of fingerprint strings each representing a portion of the exemplar file data;
wherein, processing the candidate file data to generate a candidate file fingerprint representing the candidate file, comprises: applying a rolling hash function to the candidate file data to generate a sequence of strings, and adding to the candidate file fingerprint a fingerprint string comprising a substring from the sequence of strings when a predetermined string pattern appears in the sequence of strings.

2. The method according to claim 1 wherein the exemplar file fingerprint is generated by:
receiving the exemplar file comprising exemplar file data; and
processing the exemplar file data to generate the exemplar file fingerprint representing the exemplar file, the exemplar file fingerprint comprising the plurality of fingerprint strings each representing a portion of the exemplar file data;
wherein, processing the exemplar file data to generate the exemplar file fingerprint, comprises: applying the rolling hash function to the exemplar file data to generate a sequence of strings, and adding to the exemplar file fingerprint a fingerprint string comprising a substring from the sequence of strings when the predetermined string pattern appears in the sequence of strings.

3. The method according to claim 1 wherein comparing the candidate file fingerprint with the exemplar file fingerprint representing the exemplar file, comprises: calculating a Jaccard similarity index across the fingerprint strings of the candidate file fingerprint and the exemplar file fingerprint.

4. The method according to claim 1 wherein comparing the candidate file fingerprint with the exemplar file fingerprint representing the exemplar file, comprises: computing a value indicative of the similarity of the comparison, and further comprising:
indicating, based on a predetermined threshold of the value, that the candidate file matches the exemplar file.

5. The method according to claim 1 further comprising:
receiving at least a second candidate file comprising second candidate file data; and
processing the at least a second candidate file data to generate at least a second candidate file fingerprint representing the at least a second candidate file, the at least a second candidate file fingerprint comprising a plurality of fingerprint strings each representing a portion of the at least a second candidate file data; and
wherein, processing the at least a second candidate file data to generate at least a second candidate file fingerprint representing the at least a second candidate file, comprises: applying the rolling hash function to the at least a second candidate file data to generate a sequence of strings, and adding to the candidate file fingerprint a fingerprint string comprising a substring from the sequence of strings when the predetermined string pattern appears in the sequence of strings; and
wherein the candidate file and the at least a second candidate file are disposed in a common directory, or on a common disk, or distributed across an estate of computers and/or associated storage systems.

6. The method according to claim 1 wherein the candidate file and/or the exemplar file is an executable file or a Dynamic Link Library file.

7. The method according to claim 1, wherein:
applying a rolling hash function to the candidate file data to generate a sequence of strings comprises executing a Rabin-Karp Rolling Hash algorithm.

8. A computer program product comprising instructions which when executed on a processor cause the processor to carry out the method according to claim 1.

9. The method according to claim 1 wherein the method is performed on a single core of a processor.

10. A method of generating a candidate file fingerprint representing a candidate file, comprising:
receiving the candidate file comprising candidate file data; and
processing the candidate file data to generate the candidate file fingerprint representing the candidate file, the candidate file fingerprint comprising a plurality of fingerprint strings each representing a portion of the candidate file data;
wherein, processing the candidate file data to generate a candidate file fingerprint representing the candidate file, comprises: applying a rolling hash function to the candidate file data to generate a sequence of strings, and adding to the candidate file fingerprint a fingerprint string comprising a substring from the sequence of strings when a predetermined string pattern appears in the sequence of strings.

11. The method according to claim 10 wherein adding to the candidate file fingerprint the fingerprint string comprising a substring from the sequence of strings when the predetermined string pattern appears in the sequence of strings, comprises: applying a submask to the sequence of strings.

12. The method according to claim 11 wherein applying the submask to the sequence of strings, comprises:
for each of n positions in the submask, comparing a value in the submask with a corresponding value in each string in the sequence of strings, and adding to the candidate file fingerprint the fingerprint string comprising the substring from the sequence of strings if every value in the submask is identical to its corresponding value in the string in the sequence of strings.

13. The method according to claim 10 wherein adding to the candidate file fingerprint the fingerprint string comprising the substring from the sequence of strings when the predetermined string pattern appears in the sequence of strings, comprises: only adding to the candidate file fingerprint the fingerprint string comprising the substring from the sequence of strings if said fingerprint string is distinct from every other fingerprint string already included in the candidate file fingerprint.

14. The method according to claim 10 further comprising:
processing the candidate file data to generate a second candidate file fingerprint representing the candidate file, the second candidate file fingerprint comprising a plurality of fingerprint strings each representing a portion of the candidate file data;
wherein, processing the candidate file data to generate a second candidate file fingerprint representing the candidate file, comprises: applying a second rolling hash function to the candidate file data to generate a second sequence of strings, and adding to the second candidate file fingerprint a fingerprint string comprising a substring from the second sequence of strings when a second predetermined string pattern appears in the second sequence of strings; and
wherein the second candidate file fingerprint is generated simultaneously with the candidate file fingerprint.

15. The method according to claim 10 further comprising:
linking the candidate file fingerprint to the candidate file.

16. The method according to claim 10 wherein the candidate file is an executable file or a Dynamic Link Library file.

17. The method according to claim 10, wherein:
applying a rolling hash function to the candidate file data to generate a sequence of strings comprises executing a Rabin-Karp Rolling Hash algorithm.

18. A computer program product comprising instructions which when executed on a processor cause the processor to carry out the method according to claim 10.
